(19) United States
(12) Patent Application Publication
(10) Pub. No.: US 2021/0251257 A1
(43) Pub. Date: Aug. 19, 2021

(54) COMPOSITIONS, METHODS, SYSTEMS TO ADDRESS STRESS, STARVATION, IMPROVED HEALTH, IMPROVED WATER QUALITY, PRODUCTIVITY AND LIFE EXPECTANCY OF FISHES

(71) Applicant: N. A. Mahalakshmi SRINIVASAN, Mumbai (IN)

(72) Inventor: N. A. Mahalakshmi SRINIVASAN, Mumbai (IN)

(21) Appl. No.: 17/049,062

(22) PCT Filed: Nov. 17, 2019
(86) PCT No.: PCT/IN2019/050850

§ 371 Date: Oct. 20, 2020

(30) Foreign Application Priority Data
Dec. 6, 2018 (IN) 201821046160

(51) Int. Cl. A23K 10/18; A23K 50/80; A01K 61/10

(52) U.S. Cl. CPC A23K 10/18; A01K 61/10; A23K 50/80

(57) ABSTRACT

The present disclosure generally relates to compositions, methods, systems to address stress, starvation, improved health, water quality, productivity and life expectancy of fishes; for both Ornamental fishes and Edible fishes. They enable close to 0% mortalities during transportation and throughout the distribution chain of the Aquaculture industry. The product serves as probiotic, prebiotic, improves water quality due to which lesser than prescribed amount of water can be used and water is changed with lesser frequency. Proportions and components of the compositions, the methods and systems could be varied and customised. The composition(s) comprise of bacteria with Accession Numbers: MCC0148, MCC0149, MCC0150. There are other probiotic bacteria which could be used in the composition(s) in a prescribed manner. The applications are throughout the distribution chain of Aquaculture industry and production unit of the product could be made an integral setup of farms, aquariums, warehouses.

### TECHNICAL FIELD

The present disclosure generally relates to compositions, methods, systems to address stress, starvation, improved health, improved water quality, productivity and life expectancy of fishes; includes both Ornamental fishes and Edible fishes. The product addresses the concerns associated with Aquaculture industry, giving better living conditions for the fishes and eliminates the kind of stress, starvations which could be encountered throughout the distribution chain of the Aquaculture industry. The product serves as probiotic, prebiotic, cleanses the water. Also, with this product the water used at aquariums needs to be replaced with lesser frequency and amount of water used for transportation could be lesser than the currently prescribed amounts in the protocols. The compositions, methods, systems enable disease control, improvement of digestion, improvement in immune system, improvement in color, more compatible with other fishes, compositions could serve source of nutrients, growth promotors and promotor of reproduction. These features mentioned are the major characteristics of the composition(s) and each of the composition(s) address the various health parameters associated with the different type of fishes. The composition(s) and the proportions of the components of the composition(s) could be varied to be specific for the fish type. The product has applications throughout the distribution chain of Aquaculture industry, starting from farms, warehouses, retailers, end users. The production unit for this product could be made an integral setup of Aquaculture farms, aquariums.

### BACKGROUND

Background description includes information that may be useful in understanding the present invention. It is not an admission that any of the information provided herein is prior art to the presently claimed invention, or that any publication specifically or implicitly referenced is prior art.

The invention addresses concerns associated with Aquaculture industry. The product enables close to 0% mortalities; one of the reasons of mortalities being associated with stress and starvation during transportation, at aquariums and farms, the product improves water quality by reducing nitrates, nitrites and ammonia close to 0 ppm and maintaining at that level, water needs to be replaced with lesser frequency and packaging of fishes can happen in transportation bags with lesser amount of water, product serves as a prebiotic and probiotic, composition(s) can be used in different proportions, composition(s) could be modulated in terms of the various components and parameters of the composition(s).

The ecologists express concerns about over fishing considering the fact that the actual mortalities associated with the industry aren't revealed. Fishing can lead to affecting the marine ecosystem, reduce density of the fishes in a given ecosystem and alter the balance of the ecosystem which is not due to gradual changes through natural succession.

Fish farming requires that mortalities of fishes is minimised, considering the industry deals with livestocks apart from the fact that this invention shall improve productivity.

There are number of products available. But the technologies available currently do not get down mortalities close to 0% or get the various parameters of water—nitrates, nitrites and ammonia close to 0 ppm and maintain at that level. Further, the composition(s) of this invention serves both as a prebiotic and probiotic.

The statistics from ‘Food and Agriculture Organization of the United Nations’, SOFIA (State of Fisheries and Aquaculture), 2018 provides the official world fishery and aquaculture statistics. Global fish production peaked at about 171 million tonnes in 2016. With capture fishery production relatively static since the late 1980s, aquaculture has been responsible for the continuing impressive growth in the supply of fish for human consumption.

There are numerous literatures available with regard to the Ornamental fish industry statistics. This Ornamental Fish industry data mentioned here has been provided by ‘Ornamental Fish International (OFI)’. The ornamental fish industry includes more than 120 countries in the collection, breeding, import and export of ornamental fish. FAO data suggest that exports were worth approximately $330 million USD in 2011, with the number of fish traded estimated at approximately 1.5 billion fish per annum. However, accurate trade data about the industry is difficult to obtain as statistics vary from different countries in terms of data collected, format and reliability. It is generally considered that FAO data are the most accurate, although it is likely to be significantly lower than actual trade (some industry sources suggest actual trade being between 30-40% higher than FAO figures), but illustrates generally strong and sustained growth of exports of the past 20 years.

The European Union, collectively, is the largest market for ornamental fish; however, the United States (US) is the single largest importing country for ornamental fish in the world. The prices of fish at the retail level may be several times higher than at the farm gate. This value chain can be extended through additional middlemen who aggregate supplies of fish for export, or who distribute to wholesalers, all of which add to the end cost of fish. The ornamental fish industry is generally segmented based on whether fish are tropical or temperate, freshwater or marine. The three categories are: Tropical Freshwater, Temperate (Coldwater) Freshwater, Marine Ornamentals. The Tropical Freshwater fishes are the most popular, 800 plus species, accounts for more than 50% of trade. (For example: Guppies, Neon Tetra). The Temperate (Coldwater) Freshwater accounts for 45% of trade and the majority farmed (For example: Koi Carp, Goldfish). Temperate (Coldwater) Freshwater fishes account for 45% of trade and the majority farmed.

A literature of ‘2019-2024 Global Ornamental Fish Market Trends, Outlook and Consumption Growth Opportunities and Industry, Demand, and Forecast’, 2019, Reuters, states that the worldwide market for Ornamental Fish is expected to grow at a CAGR (Compound Annual Growth Rate) of roughly 6.1% over the next five years, will reach 12000 million US$ in 2024, from 8380 million US$ in 2019, according to a new GIR (Global Info Research) study.

### OBJECTIVES OF THE INVENTION

The objectives of the present disclosure relates to compositions, methods, systems to address stress, starvation, improved health, improved water quality, productivity and life expectancy for fishes. This includes the edible fishes, ornamental fishes. The product addresses the concerns associated with Aquaculture industry, giving better living conditions for the fishes and eliminates the kind of stress, starvations they would face throughout the distribution chain of the Aquaculture industry. The product serves as probiotic and prebiotic. Also, with this product the water used at aquariums needs to be replaced with lesser frequency and amount of water used for transportation could be lesser than the currently prescribed amounts in the protocols. There is improvement in color and fishes are more compatible with each other. These features mentioned are the major characteristics of the composition(s) and each of the composition(s) could be modulated to be specific for a given fish type. The product has applications throughout the distribution chain, starting from farms, warehouses, retailers, end users. The production unit for the product could be made an integral setup of Aquaculture farms,

One objective is to develop a composition(s) which eliminates stress and starvation associated with fishes,

Another objective is to get mortalities of fishes close to 0% during transportation; Death On Arrival (DOA), Death After Arrival (DAA), Death After 7 days Of Arrival (DA7) to be maintained close to 0%. Also the objective is to maintain mortalities at aquariums, farms and throughout the distribution chain close to 0%.

Another objective is to develop composition(s) which serve as probiotic for fishes,

Another objective is to develop composition(s) which serve as prebiotic,

Another objective is to reduce nitrates, nitrites and ammonia build-up and maintaining at low ppm, close to 0 ppm,

Another objective is to develop composition(s) with which the fishes could be pretreated,

Another objective is to develop composition(s) by which water needs to be replaced with lesser frequency at farms, aquariums and packaging for transportation can happen with water lesser than the amount prescribed in existent protocols,

Another objective is to develop composition(s) which could be incorporated into Recirculating Aquaculture System (RAS),

Another objective is to develop composition(s) specific for the different types of fishes by fine tuning the proportions of the components of the composition(s),

Another objective is to develop composition(s) which enable fishes to acclimatize in new environments in a very short time,

Another objective is to develop composition(s) such that their production units could be made an integral setup of farms. This requires easy procedures for scaling up in order to cater from the farming stage, through the distribution chain to end user. The product could also be sold throughout the distribution chain of aquaculture as a manufactured product.

Various objects, features, aspects and advantages of the present invention will become more apparent from the detailed description of the invention and accompanying figures.

### SUMMARY

The present disclosure generally relates to compositions, methods, systems to address stress, starvation, improved health, improved water quality, productivity and life expectancy for fishes. This includes the edible fishes, ornamental fishes. The product addresses the concerns associated with Aquaculture industry, giving better living conditions for the fishes and eliminates the kind of stress, starvations they would face throughout the distribution chain of the Aquaculture industry. The product serves as probiotic and prebiotic. Also, with this product the water used at aquariums needs to be replaced with lesser frequency and amount of water used for transportation could be lesser than the currently prescribed amounts in the protocols. There is improvement in color and fishes are more compatible with each other. These features mentioned are the major characteristics of the composition(s) and each of the composition(s) address the various health parameters associated with each type of fishes. The composition(s) could be modulated in terms of the components and their respective proportions and be made highly specific for a given fish type. The product has applications throughout the distribution chain, starting from farms, warehouses, retailers, end users. The production unit for the product could be made an integral setup of Aquaculture farms.

The three bacterial species used in the composition(s) individually and as a combination of them in varied proportions are bacteria with Accession Numbers MCC0148, MCC0149, MCC0150. However, the scope of this invention isn't limited to these three bacteria and other bacteria could be used in the composition(s) which could render these benefits to the Aquaculture industry. Further, as stated earlier, each of the component(s) of the composition(s) could be varied and for each variation chosen, different proportions of each of the components could be used. The variations used in this manner, could be highly specific for a given fish type.

Various objects, features, aspects and advantages of the inventive subject matter will become more apparent from the following detailed description of preferred embodiments, along with accompanying figures.

### DESCRIPTION OF THE DRAWINGS

The accompanying drawings are included to provide further understanding of the present disclosure, and are incorporated in and constitute a part of this specification. The drawings illustrate exemplary embodiments of the present disclosure and together with the description, serve to explain the principles of the present disclosure.

FIG. 1 illustrates an exemplary photograph of Molly treated with different composition(s) for a duration of 9 days. Water wasn't changed for these 9 days, no other additives were used. Fishes were fed twice a day with fish food pellets. Stress factors were aeration stopped for hours, the amount of water used was lesser than prescribed amounts and not changed, the bowl only had an aeration facility and the composition(s) added to the water in the bowl(s). The offspring of Molly are seen in this image.

FIG. 2, FIG. 3 illustrates an exemplary photograph of the Goldfishes treated with the different composition(s) for a duration of 9 days. Water wasn't changed for these 9 days, no other additives were used. Fishes were fed twice a day with fish food pellets. Stress factors were aeration stopped for hours, the amount of water used was lesser than prescribed amounts and not changed, the bowl(s) only had an aeration facility and the composition(s) added to the water in the bowl(s). Experiment was for 9 days.

FIG. 4 illustrates an exemplary photograph of Koi fishes treated with different composition(s) for a duration of 9 days. Water wasn't changed for these 9 days, no other additives were used. Fishes were fed twice a day with fish food pellets. Stress factors were aeration stopped for hours, the amount of water used was lesser than prescribed amounts and not changed, the bowl(s) only had an aeration facility and the composition(s) added to the water in the bowl(s).

FIG. 5 illustrates an exemplary photograph of Veiltail Angelfishes in transportation bags treated with the composition(s). The bags had 10 Veiltail Angelfishes that survived in the bags for 40 hours and water lesser than prescribed amounts. At the end of 40 hours, no mortality was observed and fishes acclimatised in tanks well and in a short time.

FIG. 6 illustrates an exemplary photograph of Molly with their offspring in the bowl to which the composition(s) were added. Stress factors were aeration stopped for hours, the amount of water used was lesser than prescribed amounts and not changed, the bowl(s) only had an aeration facility and the composition(s) added to the water in the bowl(s).

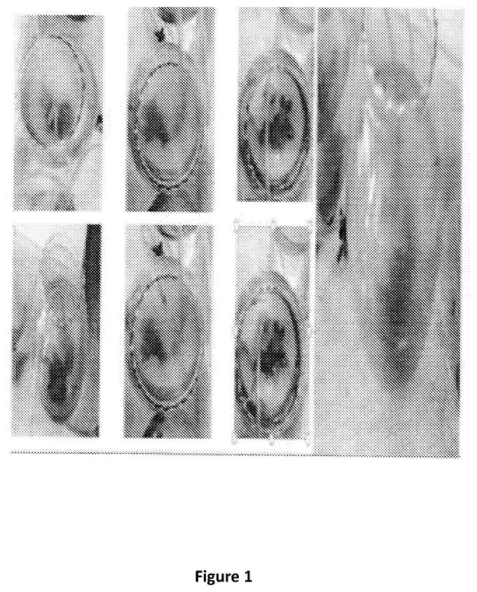

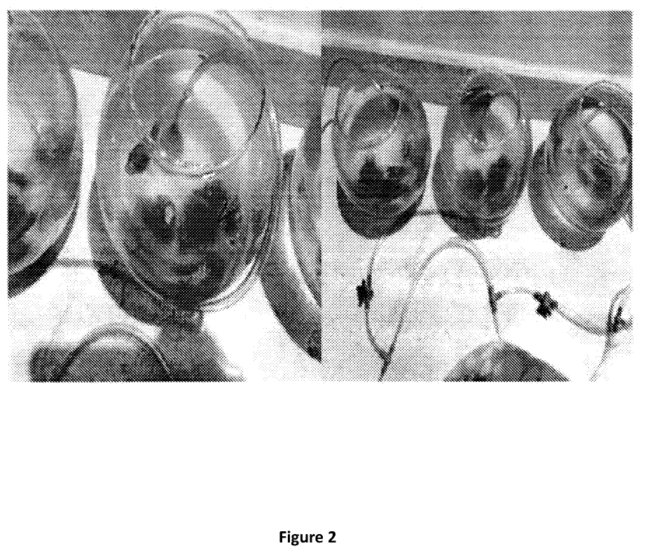

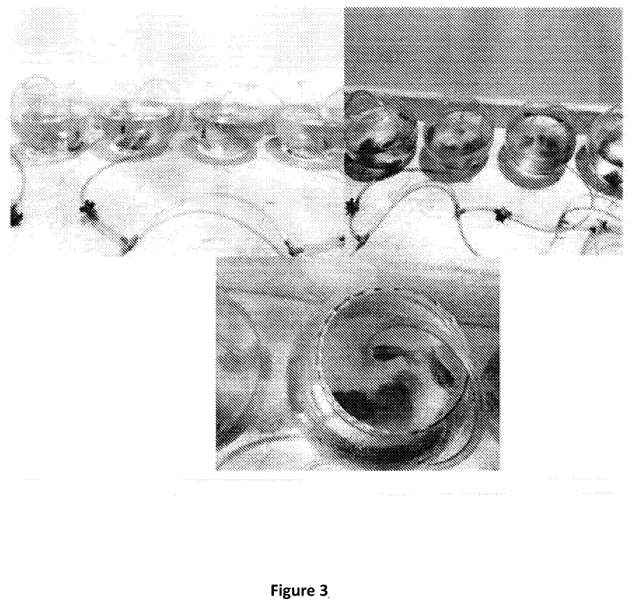

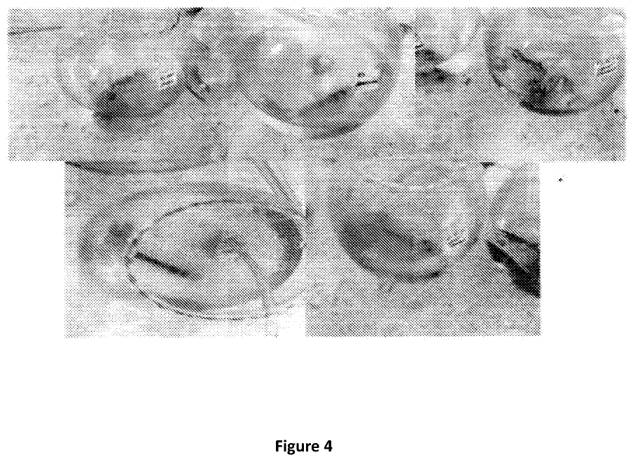

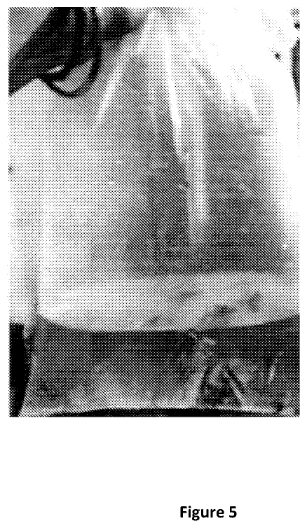

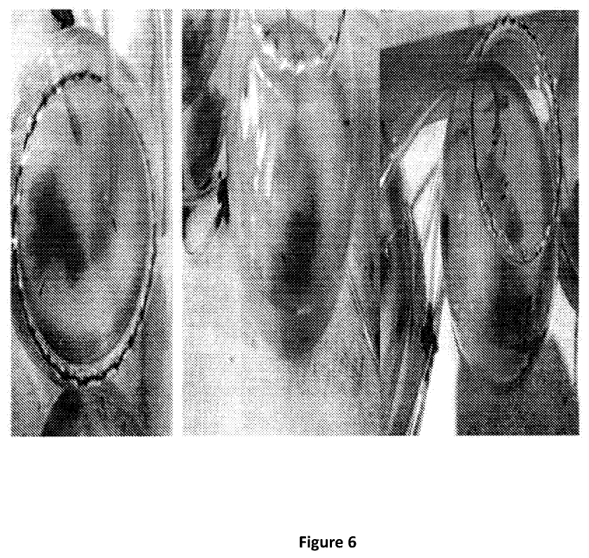

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents and alternatives falling within the spirit and scope of the present disclosure as defined by the appended claims.

Each of the appended claims defines a separate invention, which for infringement purposes is recognised as including equivalents to the various elements or limitations specified in the claims. Depending on the context all references below to the “invention” may in some cases refer to certain specific embodiments only. In other cases it will be recognised that references to the “invention” will refer to subject matter recited in one or more, but not necessarily all of the claims.

As used in the description herein and throughout the claims that follow, the meaning of “a”, “an”, “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadcast definition persons in the pertinent art have given that term as reflected in printed publications and issued patents at the time of filing.

There are numerous bacteria which could be a part of the composition(s) of this invention. The bacteria whose Accession Numbers have been provided in this application do render all the characteristics of the composition(s) mentioned here. These bacterial isolates were obtained from Rice Rhizospheres, at Maharashtra, India. 18 bacteria were isolated from these Rice rhizospheres. These bacteria based on biochemical characteristics, Antibiotic Sensitivity Testing (AST), Whole Genome Studies using NGS, could be classified under the family Pseudomonadaceae. The whole genome sequences of these isolates were found to match to the known species of Pseudomonas within the range of 75%-85%.

Each of the bacteria in the composition(s) used either individually or in combination(s) in the composition(s) were found to be highly beneficial for fishes. The bacterial composition(s) of individual bacteria comprised of the bacteria plus culture medium and a nutritive media. The culture medium could serve as nutritive medium as well. Accordingly, the composition(s) using these three bacteria were: MCC0148 suspension plus culture media and nutritive media, MCC0149 suspension plus culture media and nutritive media, MCC0150 suspension plus culture media and nutritive media. The composition comprising of the three bacteria were (MCC0148+MCC0149+MCC0150) suspension+culture media and nutritive media; bacteria in proportions ranging from (0.5:0.5:2) to (1:1:3). One example of culture medium which could also serve as nutritive media is Nutrient Broth. The bacteria used in the composition(s) were incubated in culture media for a minimal time of 48 hours before being used in the composition(s). The bacterial suspensions over cell pellets was preferred in preparing the composition(s). Culture media proportional to the volume of bacterial suspensions being used was added to the bacterial suspensions, media preferably used in a dehydrated form. However, there could be alterations in the proportions of the culture media used and the form in which the culture media is being used, whether dehydrated or as a suspension of media. The culture media could be altered considering the incubation time of the bacteria being used in the composition(s). Also, the bacterial cell mass instead of suspension could be used in preparing the composition(s).

The process or method for preparing the composition(s) involves taking aliquots of the bacterial suspensions incubated for a particular duration of time (minimum of 48 hours) and adding the culture media and nutritive media, mixing for about 1-5 minutes and then introducing into tanks, farms or transportation bags for fishes. The composition(s) could be used for Ornamental fishes and Edible fishes. A volume of 1 ml of the composition(s) was used for 1 litre of water. So, for example, if a fish was in a tank with 1 litre of water, then 1 ml of the composition(s) was added. If the tank had 5 litres of water, then 5 ml of the composition(s) was used. This is applicable for all the composition(s) and the simplest process or method, there could be variations to this process or method. Variations could be in the composition(s) being used and the amount of the composition(s) being used. Above mentioned process is only an example and there could be numerous variations to the same.

There could be variations in this process or method in terms of the form in which the bacteria is being used in the composition(s)—either as cell mass or suspensions, the incubation times chosen for the bacteria used in the composition(s), the proportions of culture media added to the bacterial suspension, the kind of culture media being used and it could be a custom culture media composition(s) as well, the combination(s) of bacteria being used in the composition(s). The bacteria could be used in the composition either individually or in combination(s), in the composition(s). The density of fishes, the amount of water too have a role in deciding the proportion(s) and component(s) of the composition(s), in order to serve as prebiotic, probiotic and to cleanse the water.

To elaborate further, variations could be there considering the various growth parameters for the bacteria, their incubation times and the type of fishes for which the composition(s) are being prepared, the kind of culture media chosen, the nutritive media chosen, the proportions of the three bacteria used in the composition(s) in permutations or combinations or if composition(s) are prepared using the individual bacteria, whether the bacteria are used as suspension cultures or as cell pellets, the extent of role of the composition(s) in cleansing water and serving as probiotic and prebiotic taking into account the water quality to be addressed, the density of fishes, fish type, their food feed patterns.

The bacteria in the composition(s) for this invention aren't just restricted to the bacteria with Accession Numbers: MCC0148, MCC0149, MCC0150.

Probiotic bacteria other than the ones whose Accession Numbers have been mentioned could be used in the composition(s).

The above mentioned composition(s) served as probiotics for fishes. With inclusion of nutritive media(s), the composition(s) could serve as prebiotics as well. Also, with modulation of culture media, we could monitor the extent of growth of bacteria in the water, which enables improve water quality by reducing nitrates, nitrites and ammonia close to 0 ppm and maintaining at that level.

The culture media could also serve as the nutritive media, nutritive media is added to serve as prebiotic component of the composition(s).

The various benefits observed using the various composition(s) were close to 0% mortalities throughout the distribution chain of Aquaculture industry, nitrates, nitrites and ammonia were got down close to 0 ppm and maintained at that level, disease control, improvement in digestion, improvement in immune system, improvement in color, more compatible with other fishes, serves as source of nutrients, growth promotor, improves water quality, water needs to be changed with lesser frequency, water used can be lesser than the currently prescribed amounts, promotes reproduction.

The invention comprises of systems. These include Systems to achieve close to 0 ppm of nitrates, nitrites and ammonia at aquariums and Fish Only Tanks, Systems to incorporate the composition(s) into biofiltration system of Recirculatory Aquaculture Systems (RAS), Systems to enable the production unit of composition(s) to be an integral setup of farms, Systems to use the composition(s) for edible fishes; this system is used as a precautionary measure as these fishes are for human consumption.

The system(s) to attain close to 0 ppm of nitrates, nitrites and ammonia at aquariums could be rocks such as lava rocks into which the composition(s) could be introduced. Alternatively, it could comprise of containers such as spherical porous containers into which pieces of rocks, stones (these are examples) could be placed. The composition(s) are introduced into this container and then this container could be placed in Fish Only Tanks or aquariums. While rocks can be placed in an aquarium and improves aesthetic value, for Fish Only Tanks, the system of spherical perforated container mentioned is preferred. In the case of farms, the composition(s) could be incorporated into the biofiltration system of Recirculatory Aquaculture System (RAS). System(s) could be custom designed to enable get nitrates, nitrites and ammonia close to 0 ppm throughout the distribution chain of the Aquaculture industry.

Systems to enable the production unit of composition(s) to be an integral setup of farms, aquariums: This system for example could be a bioreactor setup with outlets connected to the farms or aquariums. Custom designed systems could be used for the production unit(s) to be placed at farms or huge aquariums or at companies involved in shipments of huge quantities of the livestocks.

Systems to use the composition(s) for edible fishes; this system is used as a precautionary measure since edible fishes are for human consumption. These ensure that the bacterial cells do not come in direct contact with the fishes for human consumption. While fishes from sea come in contact with sea microflora, subjecting the edible fishes being farmed to high cfu of the bacterial cells being used in the formulation(s) for prolonged durations may not be advisable. Such a usage would require detailed study of the interaction of the human body with these bacterial cells, considering even raw fishes are used in recipes. It would be a better approach to avoid direct interactions of the bacterial cells in the composition(s) with the edible fishes and use system(s) to obtain the benefits for the edible fishes, characteristic of the composition(s). These system(s) could be the known technologies available or could be custom designed.

The product could be provided as a manufactured product with clear instructions about the way the component(s) of the composition(s) need to be mixed and its usage.

The mortalities were got down considerably to 0% at aquariums and during transportation (DOA—Death On Arrival, DAA—Death After Arrival, DA7—Death After 7 days Of Arrival) on using these composition(s). This is applicable throughout the distribution chain of the Aquaculture industry. Water parameters such as nitrates, nitrites and ammonia were got down close to 0 ppm and maintained at that level, using the above mentioned composition(s). Water needed to be replaced with lesser frequency and could remain unchanged for around 2 weeks. The packaging of fishes could be done using lesser than prescribed amounts of water. The invention serves as probiotic, prebiotic and improves the water quality.

The invention addresses the stress and starvation associated with fishes. The stress factors which these composition(s) could address are stopping aeration for hours, usage of water lesser than prescribed amounts in the transportation bags, at aquariums, farms and throughout the distribution chain, not changing water for 2 weeks, providing lesser amount of fish feed. Also, fishes in polluted waters, when treated with these composition(s); the fishes survived the stressful environment and water quality improved.

Different composition(s) were used and in different proportions for this study and some proportions of composition(s) suited best for a particular type of fishes. However, all the bacterial composition(s) had the benefits described in the invention for all the fishes; fine tuning the proportions of the composition(s) customised these composition(s) for each of the type of Ornamental fishes and Edible fishes.

The composition of this invention isn't restricted to only the bacteria whose Accession Numbers have been provided (as one of the components of the composition(s)). There are a range of probiotic bacteria which could have the characteristics of the composition(s) mentioned for this invention.

The invention is for Ornamental fishes and Edible fishes for human consumption.

### EXAMPLES

Example 1: Using the composition(s), method(s), system(s), the mortalities of fishes were found close to 0%: Death On Arrival (DOA), Death After Arrival (DAA), Death After 7 days Of Arrival (DA7) were maintained close to 0%. Also, the mortalities were maintained close to 0% in the bowl where the fishes were subjected to stressful conditions. Close to 0% mortality could be maintained throughout the distribution chain of aquaculture industry:

Some of the representative fishes for the study were Veiltail Angel fishes, Koi, Goldfish, Molly, Cat fishes. They were packaged with water far lesser in amount than the one prescribed in the protocols. The amount of water used for containing 4-5 fishes of Molly, 2 of Goldfishes, 4 of Veiltail Angel fishes, 2 of Koi were 600 ml-1000 ml. Catfish was placed in a bigger container with about 3 litres of water. The fishes could survive the stressful conditions, when the composition(s) were used.
The stressful conditions mainly were: not changing water for 9 days, using lesser than prescribed amounts of water, stopping aeration for hours, fish feed once or maximum twice a day, only few pellets used as feed. The modes of transportations were road ways and shipment (airways). No mortalities were observed.
These fishes were studied at aquariums, considering the same set of stress factors and the various composition(s).
Different proportions of the composition(s) were used and some proportions were best suited for particular type of fishes. Pre-treatment of fishes with the composition(s) before transportation too helped in maintaining DOA, DAA, DA7 close to 0%.
There were Veiltail Angel fishes, Angel fishes packaged in a transportation bag one less in size than the one prescribed in the protocols for packaging. Water used was much less than the prescribed amounts. The fishes were transported by air, shipment time nearly 40 hours, no mortalities were observed.
There were no additives used in these experiments other than the formulation(s).
The composition(s) used in this study were: MCC0148 plus culture media, nutritive media, MCC0149 plus culture media, nutritive media, MCC0150 plus culture media, nutritive media, (MCC0148:MCC0149:MCC0150) in a range of proportions of (0.5:0.5:2) to (1:1:3), in proportions to serve as a probiotic and to improve water quality.
There could be varied nutritive additives which could be used to further serve as prebiotic. The culture media could serve as nutritive media. The fishes described here are only representative and the invention is applicable for all fishes, both Ornamental fishes and Edible fishes.

Example 2: Composition(s), method(s), system(s) eliminates stress and starvation associated with the fishes: The fishes were placed in a bowl with water close to 600 ml-1 litre, two fishes per bowl, water not changed for 9 days, aerations stopped for hours and fish feed in minor amounts, feed twice a day and sometimes once a day. The composition(s) were added to these bowls. There were controls for the experiment. Koi fishes are representative examples and the invention is applicable for all fishes.

One indicator of stress levels could be the Blood lactate levels. Koi fishes were treated with different composition(s) and there were controls. Only the Koi fishes treated with these composition(s) survived and their blood lactate levels (one of the indicators of stress) was estimated to be at 0.2 mmol/L. Certain composition(s) in certain proportions were best suited for this stressful condition. For example, for Koi fishes, the composition(s) with bacterial proportions of (2:1:1), (2:0.8:0.77) for (MCC0148:MCC0149:MCC0150) were preferred. Also, the composition(s) with only bacteria having Accession Number MCC0150 had the same efficacy. The control fishes couldn't survive these stressful conditions. There are numerous other parameters to quantitatively express stressful conditions such as blood parameters.
This confirms the efficacy of the invention for the numerous benefits described in this application. The Koi fish mentioned here is only a representative example and the composition(s), method(s), system(s) addresses stress and starvation associated with fishes; both Ornamental fishes and Edible fishes. Also, the proportion(s) of the components of the composition(s) used in this example is representative and a range of proportion(s) of different permutations and combinations could be used for the composition(s). The invention isn't restricted to only these fishes and are applicable for all fishes, both Ornamental fishes and Edible fishes.

Example 3: The composition(s), method(s), system(s) reduce nitrates, nitrites and ammonia build-up and maintain at low ppm, close to 0 ppm. This enables usage of lesser amount of water during transportation and water needs to be replaced with lesser frequency.

Th nitrates, nitrites and ammonia levels in water are got down to low levels, close to 0 ppm and maintained at that level. This involves usage of the composition(s), system(s) and method(s). The system could comprise of materials like lava rocks which is porous. The composition(s) could be added to this rock and then placed into the aquarium. In the case of Fish Only Tanks, the system could be varied. For example, a spherical container with perforations, inside which densely packed rocks are placed (rock is an example) and the composition(s) is added to these containers. For farms, the composition(s) could be integrated into the Recirculatory Aquaculture System (RAS) to improve the water quality, by reducing nitrates, nitrites and ammonia close to 0 ppm and maintaining at that level.
The representative fishes for the study includes Koi Fishes, Angel fishes, Goldfishes, Molly, Cat fishes. These fishes were observed for their ability to survive in the environment, in presence of high nitrates, nitrites and ammonia in the presence of various composition(s) and without addition of the composition(s). Fishes could survive the stressful conditions only in the presence of composition(s). The method(s) and system(s) were chosen appropriately depending on the environment being treated and the efficacies can be observed throughout the distribution chain of the Aquaculture industry. The fishes mentioned in this example are only representative and the composition(s), method(s), system(s) benefits are applicable throughout the distribution chain of the Aquaculture industry.

Example 4: Acclimatize in new environments in a short duration: The fishes following transportation, if introduced into tanks with composition(s); the time taken for adjustment is negligible. In the case of fishes pre-treated with the composition(s), the fishes following transportation could be introduced in tanks even without the composition(s) added to the tanks.

The representative fishes for the study includes Koi Fishes, Angel fishes, Goldfishes, Molly, Cat fishes. The invention isn't restricted to only these fishes and are applicable for all fishes, both Ornamental fishes and Edible fishes.

Example 5: An illustration of how the proportions of the components of the composition(s) could be altered:

The basic example of preparing composition(s) is using 48 hour old incubated bacterial cultures. The culture suspension is only one of the component of the composition(s). To this, culture media which is preferable for the bacterial growth is added. An instance is using 1 ml of suspension culture to which 0.013 gms of dehydrated Nutrient broth powder is added. This composition prepared is to be used for 1 litre of water. In case of 5 litres of water, 5 ml of composition could be used. This is just the very basic example and variations could be there considering the various growth parameters for the bacteria, their incubation times and the type of fishes for which the composition(s) are being prepared, the kind of culture media chosen, the nutritive component chosen, the proportions of the three bacteria used in the composition(s) in permutations or combinations or if composition(s) are prepared using the individual bacteria, whether the bacteria are used as suspension culture or as cell pellet, the extent of role of the composition(s) in improving water quality, serving as probiotic and prebiotic, the density of fishes, fish type, their food feed patterns. The probiotic bacteria other than the ones whose Accession Numbers have been mentioned in this specification too could be used to prepare the composition(s) to attain the various benefits characteristic of the composition(s), method(s), system(s).

Example 6: The composition(s) serve as Probiotic for fishes: The composition(s) used with the appropriate method(s), system(s) led to improved color in fishes, better appetite, improved health as was observed with the various blood parameters, fishes found to be more compatible with other fishes and less aggressive, reduced stress and starvation, which in turn improved the longevity of the fishes. Different proportions of the composition(s) were used and some proportions were best suited for particular type of fishes.

Pre-treatment of fishes with the composition(s) helped in achieving the benefits of the composition(s) as a probiotic.
The representative fishes for the study includes Koi Fishes, Angel fishes, Goldfishes, Molly, Cat fishes. The invention isn't restricted to only these fishes and are applicable for all fishes, both Ornamental fishes and Edible fishes.

Example 7: The composition(s) serve as Prebiotic for fishes and enables improve water quality: The composition(s) could serve as a prebiotic and improves the water quality. The nutritive additive plays the role of prebiotic and the culture media for proliferation of bacterial cells in the water, that enable improve water quality. The proportions of the bacteria, their incubation times, the growth parameters of the bacteria, the permutations and combinations of the bacteria, the proportions of culture media and nutritive media, the form in which culture media and nutritive media were used, which culture media and nutritive media were used, if culture media could serve as nutritive media as well; all these parameters could be modulated to address the kind of fishes and the environment in which the composition(s), method(s), system(s) are being used.

The representative fishes for the study includes Koi Fishes, Angel fishes, Goldfishes, Molly, Cat fishes. The invention isn't restricted to only these fishes and are applicable for all fishes, both Ornamental fishes and Edible fishes.

Example 8: Fish breeding observed with the composition(s), method(s), system(s): The representative example mentioned here is Molly. An example of the composition used here is formulation of bacteria with Accession number MCC0150 and Nutrient broth. After completion of 28 hours, lava rocks were added to the bowls. The 4 Mollies treated with the composition gave birth to 8 offspring. The composition best for Molly for this particular specified environment was bacterial composition comprising of bacteria with Accession Number: MCC0150.

Example 9: Production of the composition(s): With the easy to scale up procedures for the production of the composition(s), these composition(s) could be made an integral setup of aquaculture farms and throughout the distribution chain. The product could be manufactured as well to cater to the distribution chain of the aquaculture industry. The fishes mentioned in the examples are only representative and the scope of the invention isn't restricted only to these fishes.

### Advantages of the Invention

The present disclosure relates to composition(s), method(s), system(s) to address stress, starvation, improved health, improved water quality, productivity and life expectancy for fishes. This includes both the Edible fishes for human consumption and Ornamental fishes. The product addresses the concerns associated with Aquaculture industry, giving better living conditions for the fishes and eliminates the kind of stress, starvations they would face throughout the distribution chain of the Aquaculture industry. The product serves as probiotic, prebiotic, improves water quality. Also, with this product the water used at aquariums needs to be replaced with lesser frequency and amount of water used for transportation could be lesser than the currently prescribed amounts in the protocols. These features mentioned are the major characteristics of the composition(s) and each of the composition(s) address the various health parameters associated with each type of fishes. The product has applications throughout the distribution chain, starting from farms, warehouses, retailers, end users. The production unit of the composition(s) could be made an integral setup of Aquaculture farms,

The product eliminates stress and starvation associated with fishes,

The product enables close to 0% mortalities during transportation; Death On Arrival (DOA), Death After Arrival (DAA), Death After 7 days Of Arrival (DA7) are maintained close to 0%. Also, the mortalities throughout the distribution chain are maintained close to 0%,

The product serves as probiotic to fishes,

The product serves as prebiotic,

The product reduces nitrates, nitrites and ammonia build-up and maintain at low ppm, close to 0 ppm, thus improving water quality,

The fishes could be pre-treated with the product for the various benefits rendered to the fishes,

The product enables water to be replaced with lesser frequency at farms, aquariums and packaging for transportation can happen with water lesser than the amount prescribed in existent protocols,

The product could be incorporated into Recirculating Aquaculture System (RAS),

The product have varied effects on the different types of fishes. The composition(s) could be fine tuned in terms of the proportions of the components of the composition(s),

The product enables fishes to acclimatize at aquariums in a very short time,

The production unit for the product could be made an integral setup of farms.

### SEQUENCE INFORMATION

The GenBank Accession numbers for the bacteria with Accession Numbers MCC0148, MCC0149, MCC0150 are CP040012, CP040013, CP040014.

(These bacteria whose Accession Numbers have been provided are only representative bacteria and in this invention or specification other probiotic bacteria too could be used).

1. A composition for aquaculture characterised by:
addressing the stress and starvation of edible and ornamental fishes throughout the distribution chain which includes farms, aquariums, transportation bags, aquatic environments, at retail outlets and for end users,
enabling close to 0% mortalities of fishes throughout the distribution chains; at farms, at aquariums, during transportations (Death On Arrival—DOA, Death After Arrival—DAA, Death After 7 Days Of Arrival—DA7), retail outlets and end users,
pre-treatment of fishes to achieve close to 0% mortalities of fishes throughout the distribution chains; at farms, at aquariums, during transportations (Death On Arrival—DOA, Death After Arrival—DAA, Death After 7 Days Of Arrival—DA7), retailers and end users,
serving as a probiotic, enabling better health, digestion, immune system, disease control, promotor of reproductions, improvement in color,
serving as a prebiotic,
serving to improve water quality by reducing high levels of nitrates, nitrites and ammonia close to 0 ppm and maintaining at that level,
making fishes more compatible and less aggressive,
usage of water lesser than the currently prescribed amount and replacing water with lesser frequency,
enabling immediate acclimatization to the new environment the fishes are introduced, using probiotic bacteria along with nutritive media, culture media as component(s) of the composition,
variations in the composition and their proportions in permutations and combinations and along corresponding systems and methods renders the various benefits characteristic of the composition, and
systems to achieve close to 0 ppm of nitrates, nitrites and ammonia at aquariums and Fish Only Tanks, Systems to incorporate the composition into biofiltration system of Recirculatory Aquaculture Systems (RAS), Systems to enable the production unit of product to be an integral setup of farms, Systems to use the composition for edible fishes; this system is used as a precautionary measure as these fishes are used for human consumption.

2. The composition of claim 1, comprising a probiotic bacteria,

3. The composition of claim 1, comprising bacteria with at least one of Accession Numbers MCC0148, MCC0149, and MCC0150.

4. The composition of claim 3, wherein the bacteria have sequence similarity with Pseudomonas species in the range of 75% to 85%.

5. The composition of claim 3, wherein the bacteria include bacteria with only one of Accession Numbers MCC0148, MCC0149, and MCC0150.

6. The composition of claim 3, wherein the bacteria include bacteria from more than one of Accession Numbers MCC0148, MCC0149, and MCC0150.

7. The composition of claim 3, wherein the bacteria are selected from Accession Numbers MCC0148, MCC0149, and MCC0150 to be used in combinations having a ratio in the range of (0.5:0.5:1) to (1:1:3).

8. The composition of claim 1, comprising culture media which are chemically defined.

9. The composition(s) of claim 1, wherein the culture media is customised in its formulation(s).

10. The composition of claim 1, comprising nutritive media which are chemically defined and serve as a prebiotic.

11. The composition of claim 1, comprising nutritive media which serves as a prebiotic.

12. The composition of claim 8, wherein the culture media also serve as a nutritive media.

13. The composition of claim 8, wherein the culture media is proportional to the amount to be used for a given volume, as given in instructions by the manufacturer of the media.

14. The composition of claim 8, wherein the culture media is in a dehydrated form or a suspension.

15. The composition of claim 10, wherein the nutritive media is proportional to the amount to be used for a given volume, as given in instructions by the manufacturer of the media.

16. The composition of claim 10, wherein the nutritive media is in a dehydrated form or a suspension.

17. The composition of claim 13, wherein the amount of culture media is selected during preparation depending on at least one of where the composition is to be used, bacterial proportions and density, fish taxonomy, water quality, and fish density.

18. The composition of claim 15 wherein the amount of nutritive media is selected during preparation depending on at least one of where the composition is to be used, bacterial proportions and density, fish taxonomy, water quality, and fish density.

19. The composition of claim 2, wherein the bacteria are incubated for different time points.

20. The composition of claim 7, wherein the bacteria are incubated for a minimum duration of 40-48 hours.

21. The composition of claim 2, wherein bacteria are used either individually or in combinations, in the composition(s), in various proportions.

22. The composition of claim 7, wherein the composition(s) with bacterial proportions of (1:2:2)—(MCC0148:MCC0149:MCC0150) incubated for a minimum of 48 hours are used for Koi fishes, for the various characteristics mentioned in claim 1.

23. The composition of claim 7, wherein the composition(s) with bacterial proportions of (0.77:0.8:2) for (MCC0148:MCC0149:MCC0150) incubated for a minimum of 48 hours are used for Koi fishes, for the various characteristics mentioned in claim 1.

24. A method using the composition of claim 1, comprising:
placing Koi fishes in the presence of the composition for at least nine days, wherein: the Koi fishes are thereby capable of maintaining their blood lactate levels at no more than 0.2 mmol/L at the end of said nine days while the Koi fishes are subjected to stressful conditions, such as placing two Koi fishes in a bowl containing about 900 ml of water with only aeration facility, aerations stopped for hours, water not changed for said nine days, and fish feed given twice a day and few pellets.

25. The composition of claim 1, wherein the composition(s) are fine tuned for a specific fish type while maintaining the characteristics of claim 1.

26. The composition of claim 1, wherein the composition is capable of being used for all Edible fishes and Ornamental fishes.

27. The composition of claim 1, wherein the parameters for bacterial growth which could include incubation time, container used, preference to culture media, in shaker, cell pellets being used or suspension culture of the bacteria are altered based on the specifications to be met while preparing the composition.

28. The composition of claim 1, wherein the composition is highly specific for a fish type or fish taxonomy.

29. The composition of claim 1, wherein the composition has variations based on the kind of culture media chosen, the nutritive component chosen, the proportions of the bacteria used in the composition(s); in permutations or combinations or if composition(s) are prepared using the individual bacteria, the proportion(s) of the various components of the composition(s), whether the bacteria are used as suspension culture or as cell pellet, the extent of role of the composition(s) in improving water quality, serving as probiotic and prebiotic taking into account the water quality to be addressed, the density of fishes, fish type, their food feed patterns.

30. A method using the composition of claim 1, comprising:
preparing the composition(s) based on whether the composition is to be used at farms or aquariums, or during transportation, warehouses or at retail outlets, or for end users, the fish type, the quality of water, density of fishes, fish feed patterns.

31. A method for preparing the composition of claim 1, comprising:
obtaining aliquots of the bacterial suspension incubated for a minimum of 48 hours, adding the culture media, nutritive media (the culture media could also serve as nutritive media), and
mixing for about 1-5 minutes, such that the resulting composition is prepared for introduction into tanks, farms or transportation bags, or warehouses.

32. The method of claim 31, further comprising introducing the resulting composition into said tanks, farms or transportation bags, or warehouses using a volume of approximately 1 ml of the composition in 1 litre of water.

33. The method of claim 31, wherein the method is the simplest method or process to prepare the composition.

34. The method of claim 31, wherein the method could have variations in terms of the form in which the bacteria is being used in the composition(s)—either as cell mass or suspension, the incubation times chosen for the bacteria, the proportions of culture media added, the kind of culture media being used; defined or customised, the nutritive media which could be defined or customised, the combination of bacteria being used in the composition(s) or if one bacterial type being used, the density of fishes, the amount of water, quality of water, fish density, fish feed patterns in deciding the proportion(s) and component(s) of the composition(s).

35. A system using the composition of claim 1, wherein the system is adapted for ensuring bacterial cells do not get in direct contact with the edible fishes, as a precautionary measure.

36. A system using the composition of claim 1, wherein the system is adapted for reducing and maintaining nitrates, nitrites and ammonia levels close to 0 ppm as the composition is used with fishes.

37. The system of claim 36, comprising rocks, such as lava rocks, to which the composition is introduced to reduce and maintain close to 0 ppm of nitrates, nitrites and ammonia.

38. The system of claim 36, comprising a spherical container with perforations into which rocks, such as lava rocks, could be densely packed, wherein the spherical container is adapted to receive the composition.

39. The system of claim 36, wherein the system is integrated into Recirculatory Aquaculture Systems (RAS) for reducing and maintaining nitrates, nitrites and ammonia levels close to 0 ppm.

40. A system using the composition of claim 1, wherein the system is custom designed or uses existing technologies to integrate a production unit using the composition at a farm, an aquarium or a warehouse.
